(19) United States
(12) Patent Application Publication
(10) Pub. No.: US 2010/0260039 A1
(43) Pub. Date: Oct. 14, 2010

(54) NETWORK CONNECTOR

(75) Inventor: Po-Jung CHEN, Taoyuan City (TW)

Correspondence Address: BACON & THOMAS, PLLC, 625 SLATERS LANE, FOURTH FLOOR, ALEXANDRIA, VA, 22314-1176, US

(73) Assignee: U.D.ELECTRONIC CORP, Taoyuan City (TW)

(21) Appl. No.: 12/820,514

(22) Filed: Jun. 22, 2010

Related U.S. Application Data
(63) Continuation-in-part of application No. 12/216,937, filed on Jul. 14, 2008.

(51) Int. Cl. H04L 12/24

(52) U.S. Cl. 370/216

(57) ABSTRACT

A network connector includes an electronically insulative housing having first and second connection ports arranged in the front side thereof, an adapter circuit board mounted in the electrically insulative housing and having first and second conducting terminals respectively connected to the first and second connection ports, a filter module installed in the adapter circuit board and electrically connected to the adapter circuit board, and an automatic diversion device installed in the adapter circuit board and having a signal diversion component electrically connected to the first and second conducting terminals, the filter module and an external power input device in such a manner that when the external power input device fails, the automatic diversion device is turned into a close-circuit status, for enabling inputted WAN signals to be directly transmitted from the first connection port to the second connection port for output to avoid signal interruption.

This application is a Continuation-In-Part of my patent application Ser. No. 12/216,937, filed on Jul. 14, 2008.

### BACKGROUND OF THE INVENTION

1. Field of the Invention

The present invention relates to provide a network technology and more particularly, to a network connector, which enables inputted WAN signals to be directly transmitted from a first connection port to a second connection port for output without conversion through a control chip on a motherboard of an external electronic device when the power input device fails, avoiding signal interruption.

2. Description of the Related Art

Nowadays with rapid developments in computer technology, desktop or notebook computers have prevailed in every corner of our society, and the development trends of computers will also towards high computational performance, rapid processing speed and miniaturization. Moreover, as network communication technologies develop rapidly and vigorously, people are bring into another new life, study, work and leisure that has never seen before, and it is possible for the people to deliver real-time information, advertisements, or to send and receive e-mails, etc. via network communication for interaction and contact between them. At the same time, networks can be used to search for various kinds of information, enable real-time Internet communication or play online games for entertainment, thus forming a closer and more integral relationship between people and networks.

Generally, networks can be classified into such types as Local Area Network (LAN), Metropolitan Area Network (MAN), Wide Area Network (WAN) and Wireless Network and Internet, depending on geographical coverage of computers. Among these kinds of networks, the LAN is a kind of networks consisting of many independent computers that are interlinked and possibly located in different offices in the same building, or in different buildings in the same company or school. Common standards for the LAN include IEEE802.3 Ethernet, Fast Ethernet and Gigabit Ethernet, etc, in which a bridge is used to connect different network segments. In addition, the LAN architecture is adopted mainly to facilitate sharing of equipments and resources inside offices, companies or schools with extendable applications in synchronous database processing operations to achieve best results from resource applications.

Besides, the LAN can be connected to the WAN via a connection interface. In such way, the WAN can link a variety of independent computers located in different cities, countries or even continents together, as shown in FIG. 9, which is a schematic diagram of network architecture according to a prior art. Referring to FIG. 9, an equipment A is equipped with a router or a hub, which can be used to build a LAN by interconnecting at least one computer. At the same time, the equipment A is used to convert WAN signals into LAN signals, which will be further transmitted to an equipments B and C for use, and to enable many independent computers to interconnect or share resource through Internet. However, when the power supply to the router or hub in the equipment A is cut off, it is impossible for the WAN signals to be converted into the LAN signals. As a result, the equipments B and C cannot be interconnected or communicate with external networks.

Therefore, usually in the process of building networks, a signal conversion device is pre-installed at the front end of the equipments B and C to make the WAN signals be directly transmitted to the equipments B and C for use through the signal conversion device without being converted into the LAN signals through the equipment A when the power supply to the equipment A fails, thus ensuring the signal connections of the whole network will not be interrupted. Referring to FIGS. 8 and 9, automatic switch components are placed at back ends of network ports A and B. When the power supply is in normal, the WAN signals will be first inputted from the network port A for filtering by a transformer, and the filtered signals will be converted into the LAN signals by an IC chip (PHY IC Chip) and then outputted through the filter and the network port B; if there is power outage at this time, the automatic switch component will begin to work and cause short-circuit between the network port A and the network port B, allowing the WAN signals to be transmitted directly to the network port B for output via the automatic switch component. Because the WAN signals will not be converted by the IC chip in the process of transmission, the signals will not be impacted by the power supply to the IC chip, thus achieving the goal of uninterrupted transmission of network signals. However, the prior art still has problems and disadvantages as follows:

1. The network ports A and B, the automatic switch component, the filter and the IC chip are installed on the motherboard independently. Because the decrease in the space inside the electronic equipments and many electronic components arranged on the motherboard, these electronic components are installed more densely. As a result, the network signals will generate various kinds of electromagnetic interferences in the process of transmission, conversion or filtering, thus causing an increase in electromagnetic interferences on the motherboard, too. This will have negative impact on the quality of signal transmission, and may even result in interruption or failure of signal transmission in some cases.

2. Nowadays as the computer hosts or servers tend to be light, thin, short and small in size, how to reduce the size of these equipments effectively seems to become one of the most essential factors in design. However, the connection interfaces of motherboards inside the computer hosts now have been insufficient to accommodate an increasing number of peripheral devices and due to miniaturization of the motherboards, electronic components related to the peripheral devices on the motherboards are required to be repositioned into the peripheral devices. In such cases, if the motherboards are added with the automatic switch components, which will occupy some space, it not only is difficult to arrange the electronic components on the motherboards as expected, but also makes overall design too disorderly and make it difficult to reduce the size of the motherboards, and will also lead to considerable increase in production costs.

Therefore, it is desirable to provide an automatic network signal diversion mechanism that eliminates the aforesaid problems.

### SUMMARY OF THE INVENTION

The present invention has been accomplished under the circumstances in view. The primary objective of the present invention is to provide a network connector, which comprises an electrically insulative housing that has arranged in the front side thereof a first connection port and a second connection port, an automatic diverting device mounted in the electrically insulative housing and electrically connected with the first connection port and the second connection port to form a signal diversion loop and also electrically connected to a power input device. Therefore, when the power input device fails, WAN signals that are inputted into the first connection port will be directly transmitted to the second connection port for output without conversion through a data processing unit of an external electronic device, avoiding signal interruption.

The secondary objective of the present invention is to provide a network connector, which has the signal input port, the signal output port, a filter module and the automatic diversion device integrated into the electronically insulative housing. Such integration requires less installation space in the motherboard of the electronic device and saves much the cost. Further, subject to the operation of the automatic diversion device of the network connector, it is not necessary to install an extra automatic diversion device in the motherboard of the electronic device, and therefore the invention simplifies the arrangement of control circuit, connection interface and electronic components of the motherboard of the electronic device, saving much circuit layout space.

The third objective of the present invention is to provide a network connector, which uses a shield shell to surround the electronically insulative housing, forming with the motherboard of the electronic device a ground loop for guiding electromagnetic waves from the surroundings around the network connector and noises from the internal adapter circuit board to the ground terminal of the electronic device for discharge to the ground, avoiding signal interference.

### BRIEF DESCRIPTION OF THE DRAWINGS

FIG. 1 is a block diagram of a network connector in accordance with the present invention.

FIG. 2 is a circuit diagram of the network connector in accordance with the first embodiment of the present invention.

FIG. 3 is an elevational view of the network connector in accordance with the first embodiment of the present invention.

FIG. 4 is a partial sectional view of the network connector in accordance with the first embodiment of the present invention.

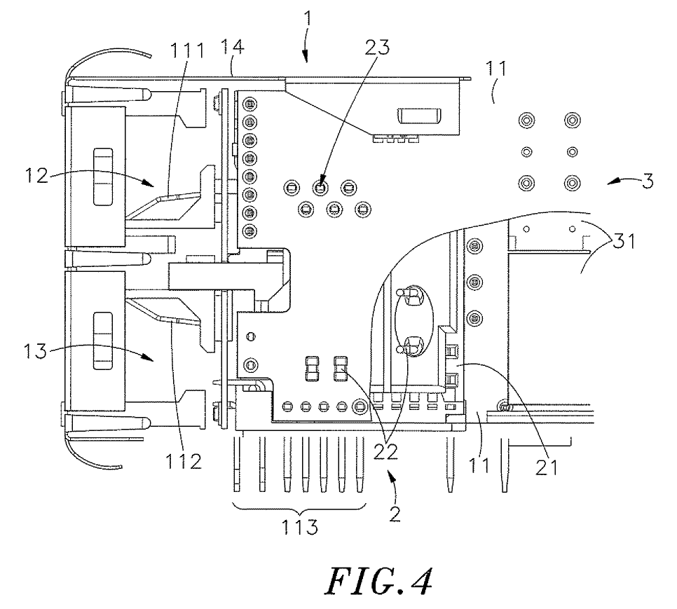

FIG. 5 is a circuit diagram of a network connector in accordance with a second embodiment of the present invention.

FIG. 6 is a circuit diagram of a network connector in accordance with a third embodiment of the present invention.

FIG. 7 is a front-view diagram of a fourth embodiment of the present invention.

FIG. 8 shows a front-view diagram of a fifth embodiment of the present invention.

FIG. 9 is a schematic diagram showing a conventional network architecture.

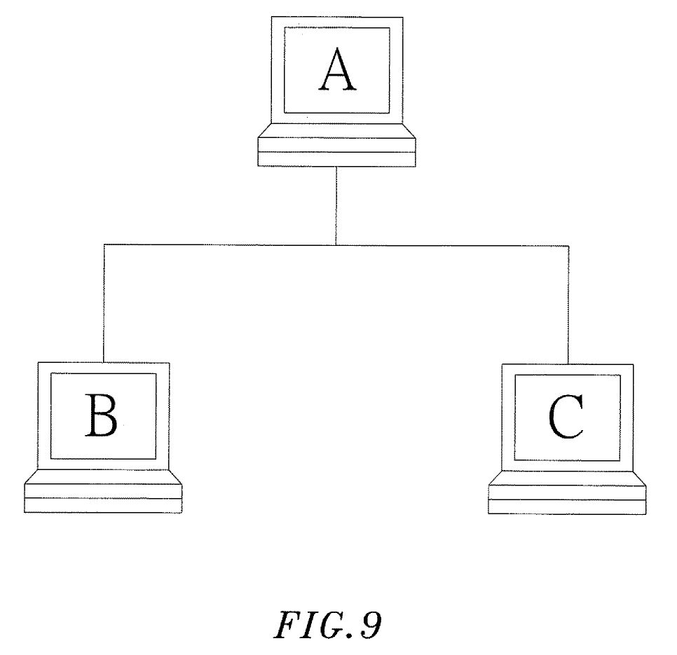

FIG. 10 is a schematic diagram of an automatic diversion device according to the prior art.

FIG. 11 is a schematic diagram of another automatic diversion device according to another prior art.

### DETAILED DESCRIPTION OF THE PREFERRED EMBODIMENT

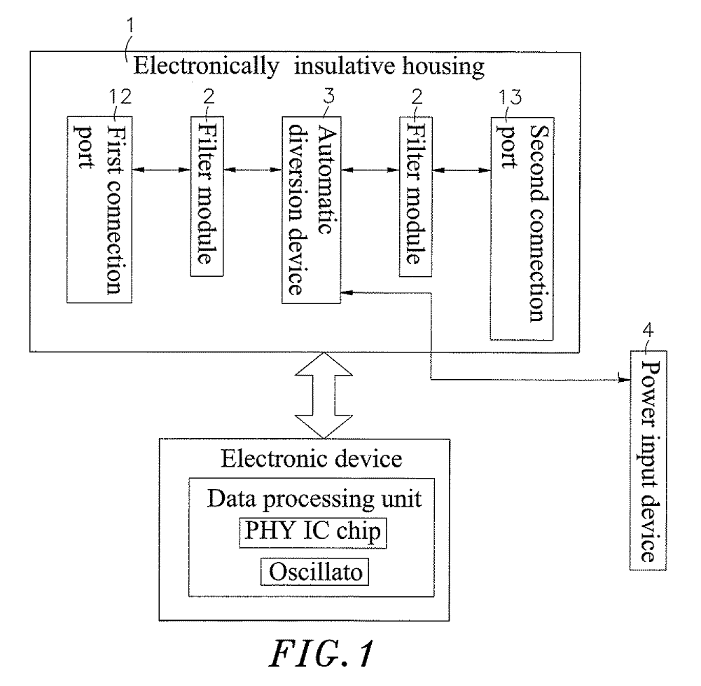

Referring to FIGS. 1˜4, a network connector in accordance with the present invention is shown comprising an electronically insulative housing 1, at least one filter module 2 and an automatic diversion device 3.

The electronically insulative housing 1 is a hollow member having accommodated therein an adapter circuit board 11, the filter module(s) 2 and the automatic diversion device 3. Further, the electronically insulative housing 1 has at least one first connection port 12 and at least one second connection port 13 located on the front side thereof. The circuit board 11 comprises a plurality of first conducting terminals 111 and second conducting terminals 112 bilaterally located on one end thereof that have the respective curved front ends respectively positioned in respective locating grooves 121 in the first connection port 12 and respective locating grooves 131 in the second connection port 13, a plurality of contacts (not shown) located on the other end thereof, and a plurality of third conducting terminals 113 located on the bottom side thereof and downwardly extending out of the electronically insulative housing 1 for connection to respective contacts on the internal motherboard of an electronic device (not shown). Further, the electronically insulative housing 1 is surrounded by a shield shell 14, which is connected to the internal motherboard of the electronic device to form a ground loop for guiding electromagnetic waves from the surroundings around the network connector and noises from the adapter circuit board 11 to the ground terminal of the electronic device for discharge to the ground.

The filter module 2 is mounted in the adapter circuit board 11 of the electronic device 1, comprising a holder member 21, a filter member 22 mounted in the holder member 21 and conducting terminals 23 mounted in the holder member 21 at two opposite lateral sides. The filter module 2 consists of a transformer, and resistors, capacitors or other passive components. The filter member 22 has the coils thereof respectively arranged around the conducting terminals 23. The conducting terminals 23 are respectively electrically connected between the contacts at the adapter circuit board 11 and respective contacts of the data processing unit of the motherboard of the electronic device for filtering noises from external WAN signals that are being transmitted from an external signal source to the data processing unit of the motherboard of the electronic device. The data processing unit of the motherboard of the electronic device comprises an Ethernet control chip (PHY IC Chip) and an oscillator. The Ethernet control chip is adapted to convert inputted WAN signals from the first connection port 12 into LAN signals for output through the second connection port 13.

The automatic diversion device 3 is installed in the adapter circuit board 11 opposite to the filter module 2, comprising at least one signal diversion component 31 that is electrically connected with the filter module 2, the first conducting terminals 111 and the second conducting terminals 112. The signal diversion component 31 can be a relay, signal switcher or any other electronic component with input/output control functions. The automatic diversion device 3 is electrically connected to a power input device 4 that provides the network connector with the necessary working voltage. The power input device 4 can be a power adapter or battery at the motherboard of the electronic device, or an external uninterruptible power supply system (UPS) or battery.

When using the network connector, the user can insert a compatible signal transmission cable into the first connection port 12 of the electronically insulative housing 1 into connection with the first conducting terminals 111 of the adapter circuit board 11 for allowing input of external WAN signals into the adapter circuit board 11 for filtration by the filter member 22 of the filter module 2 to remove noises. Filtered WAN signals are then transmitted to the data processing unit at the motherboard of the connected electronic device, and then converted by the control chip of the data processing unit into LAN signals. Thereafter, the filter member 22 of the filter module 2 filters LAN signals, and then transmits filtered LAN signals to the second conducting terminals 112 for transmission to the outside through an external signal transmission cable that is connected to the second connection port 13.

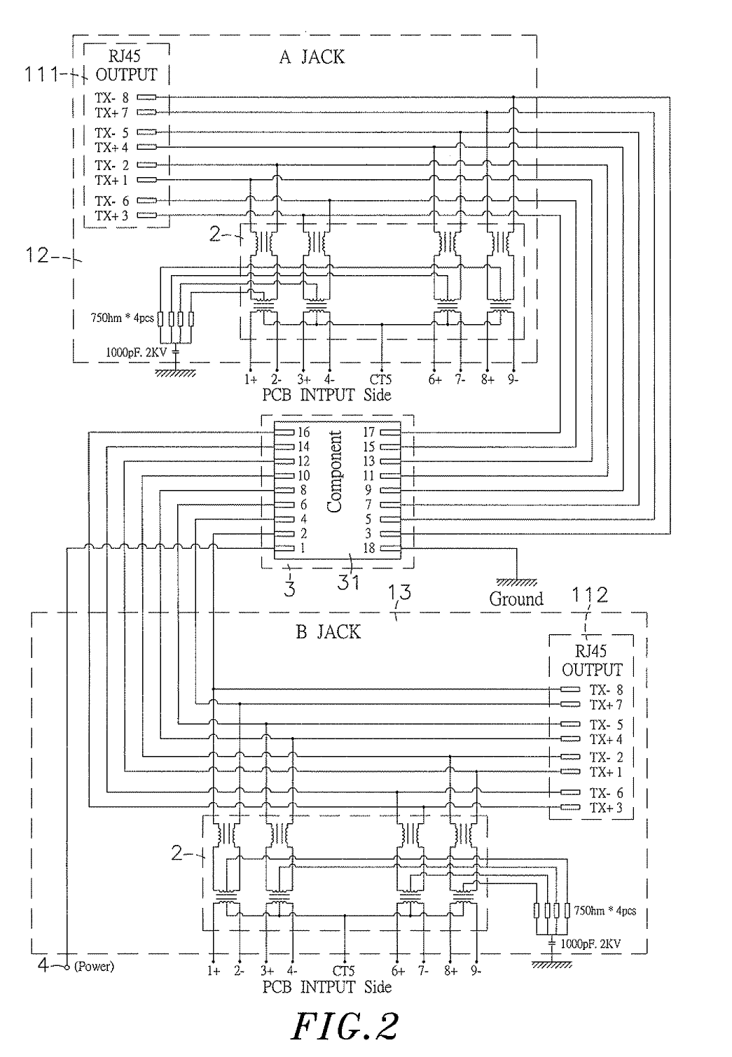

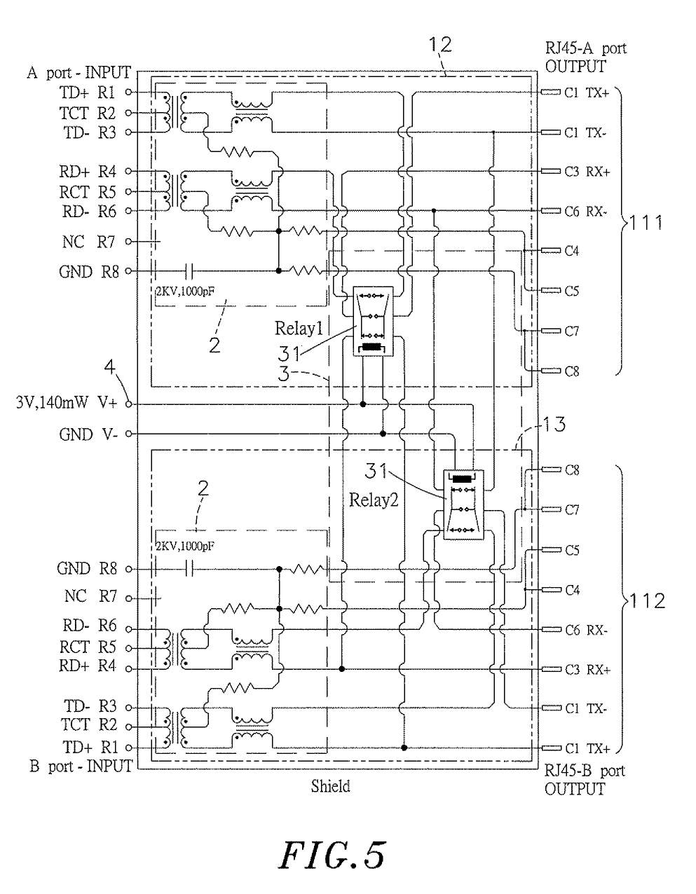

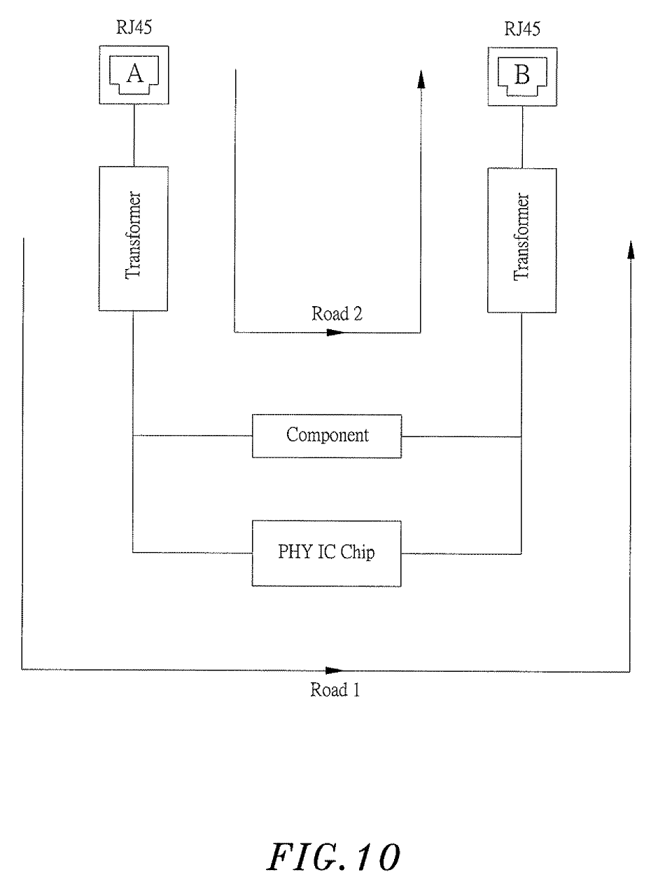

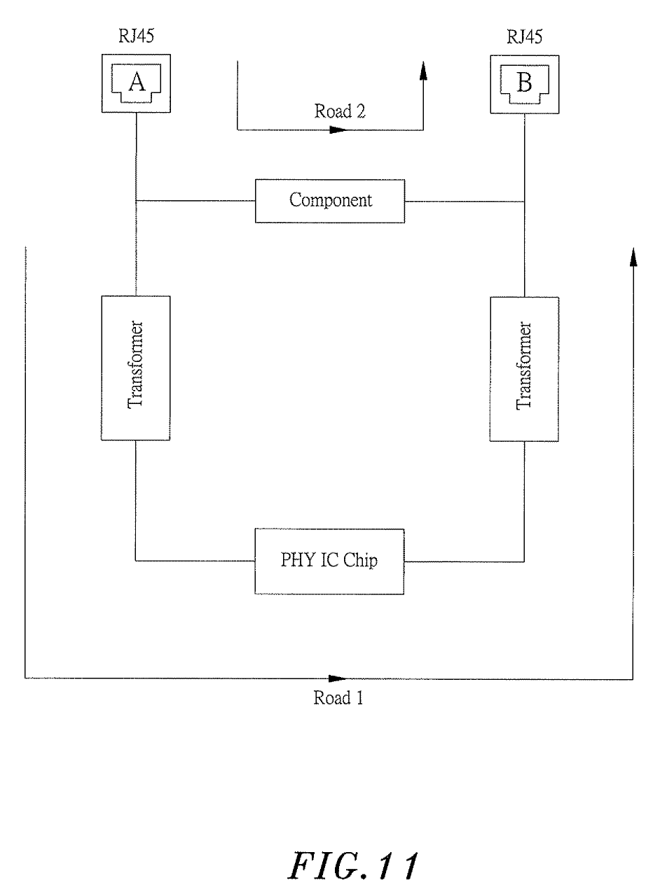

Referring to FIGS. 5˜8 and FIG. 2 again, the automatic diversion device 3 is electrically mounted in the electrically insulative housing 1, and electrically connected with the first conducting terminals 111, the second conducting terminals 112 and the filter module 2 to form a signal diversion loop. The signal diversion component 31 of the automatic diversion device 3 comprises a plurality of pins (Pin1˜Pin18 as shown in FIG. 2). One pin (Pin1) is electrically connected to the power input device 4 that provides the network connector with the necessary working voltage. During normal working of the power input device 4, the other pins of the signal diversion component 31 (Pin 2&3, Pin 4&5 . . . Pin 16&17) are kept in the open-circuit status. At this time, inputted external WAN signals are transmitted through the first conducting terminals 111 of the adapter circuit board 11 (Input +1, −2˜−8), and then converted into LAN signals and transmitted to the second conducting terminals 112 (Output +1, −2˜−8) for output (Road 1 as shown in FIG. 10 and FIG. 11). If the power input device 4 fails, the pins (Pin 2&3, Pin 4&5 . . . Pin 16&17) of the signal diversion component 31 will be turned into the close-circuit status. At this time, inputted external WAN signals are transmitted through the first conducting terminals 111 of the adapter circuit board 11 (Input +1, −2˜−8) and to the second conducting terminals 112 (Output +1, −2˜−8) for output (Road 2 as shown in FIG. 10 and FIG. 11) without through the control chip of the data processing unit for conversion into LAN signals. This structural design avoids signal interruption of the network connector due to short circuit, power outage or failure of the power input device 4.

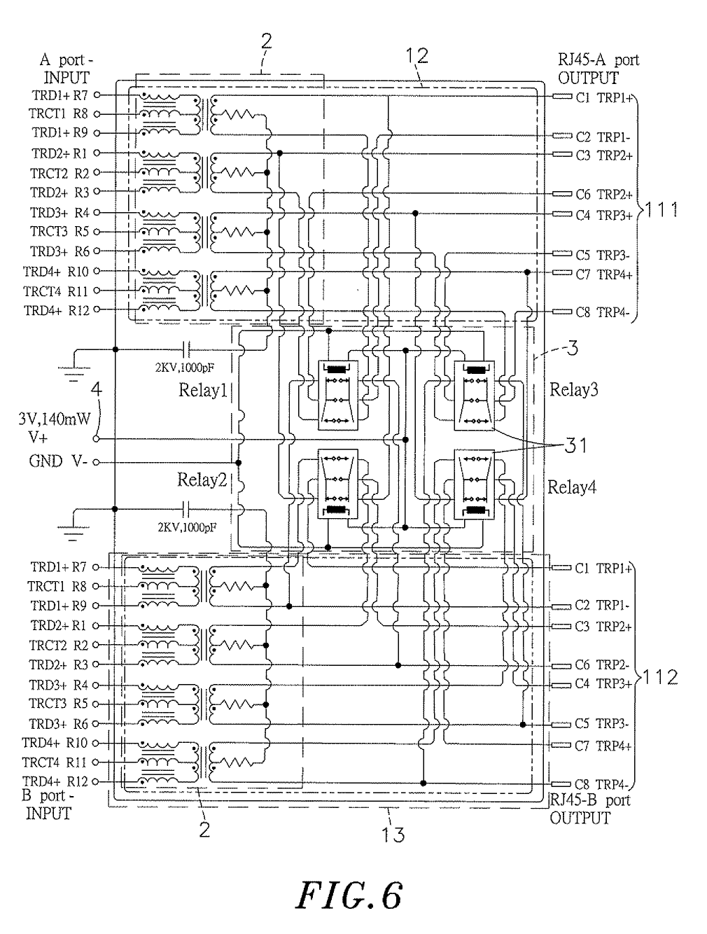

As indicated above, the at least one signal diversion component 31 of the automatic diversion device 3 and the (filter member) transformer 22 of the filter module 2 are connected in parallel to the control chip (PHY IC Chip) of the motherboard of the electronic device (see FIGS. 5 and 6).

However, in practice, the applications of the present invention are not limited to parallel or series connection arrangement. Further, the signal diversion component 31 of the automatic diversion device 3 can be connected between the filter member (transformer) 21 and the control chip (as shown in FIG. 10). Alternatively, the signal diversion component 31 can be connected between the filter member (transformer) 21 of the filter module 2 and the first connection port 12 or second connection port 13 of the electronically insulative housing 1 (as shown in FIG. 1). Thus, when the power input device 4 fails, external WAN signals being inputted into the first connection port 12 will be directly diverted by the automatic diversion device 3 and transmitted to the second connection port 13 for output to the outside without through the filter module 2, avoiding WAN signal attenuations and enhancing signal transmission stability and accuracy.

As stated above, the first connection port 12, the second connection port 13, the filter module 2 and the automatic diversion device 3 are integrated into the electronically insulative housing 1. Such integration requires less installation space in the motherboard of an electronic device and saves much the cost when compared to the conventional designs of which the components are to be separately installed in the motherboard of an electronic device. Further, subject to the operation of the automatic diversion device 3 of the network connector, it is not necessary to install an extra automatic diversion device in the motherboard of the electronic device, and therefore the invention simplifies the arrangement of control circuit, connection interface and electronic components of the motherboard of the electronic device, saving much circuit layout space. Because electronic components are densely installed in the motherboard of the electronic device, signal interference tends to occur during transmission of transmission of signals. This invention eliminates this problem. The electronically insulative housing 1 of the network connector is surrounded by the shield shell 14, which is connected to the motherboard of the electronic device to form a ground loop. Thus, electromagnetic waves from the surroundings around the network connector and noises from the adapter circuit board 11 are effectively guided to the ground terminal of the electronic device for discharge to the ground, avoiding signal interference.

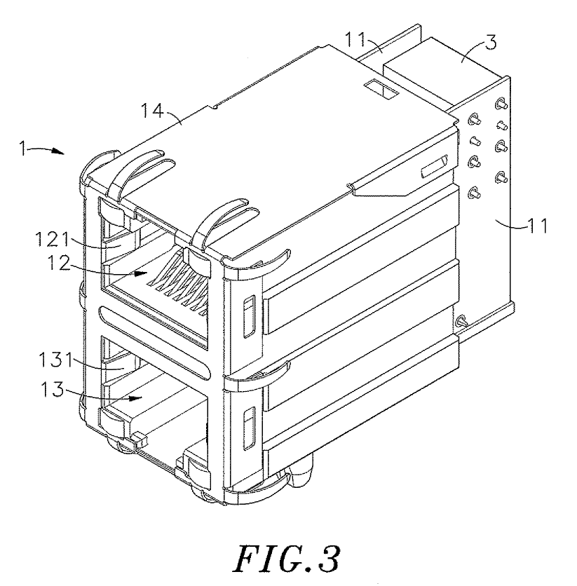

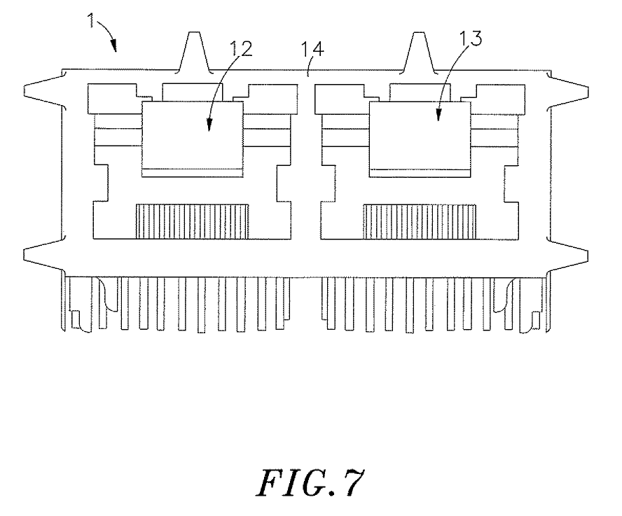

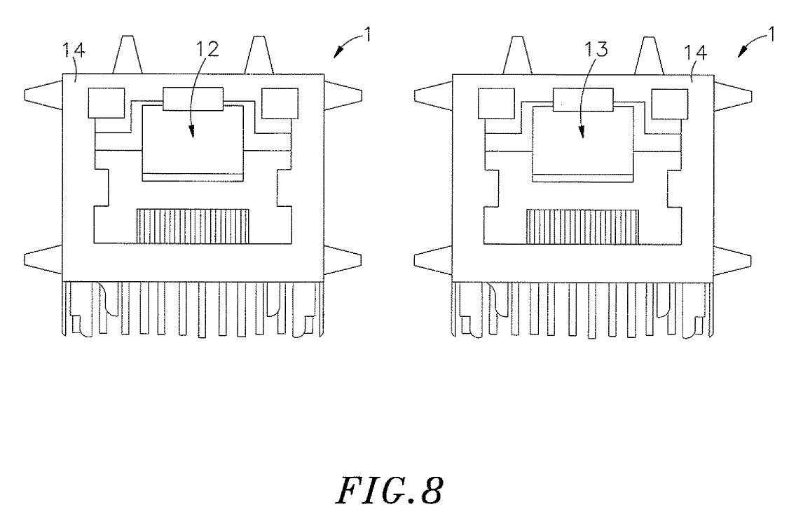

Further, the first connection port 12 and the second connection port 13 of the electronically insulative housing 1 can be Ethernet compatible RJ45 connection interfaces for the connection of multiple external network equipments. Further, the network connector can be comprised of multiple integrated layers arranged in vertical at different elevations, or in horizontal in a parallel manner (as shown in FIGS. 3 and 7). Alternatively, the network connector can be comprised of multiple detachable layers separately arranged vertical at different elevations, or in horizontal in a parallel manner (as shown in FIG. 8).

Therefore, the present invention is characterized by that the network connector comprises an electronically insulative housing 1, at least one first connection port 12 and at least one second port 13 installed in the front side of the electronically insulative housing 1, an adapter circuit board 11 mounted in the electrically insulative housing 1, and a filter module 2 and an automatic diversion device 3 with a signal diversion component 31 installed in the adapter circuit board 11 and respectively electrically connected to the first connection port 12 and at least one second port 13. The filter module 2 is adapted for removing noises from inputted WAN signals. Further, the automatic diversion device 3 is electrically connected to a power input device 4. When the power input device 4 fails, the signal diversion component 31 of the automatic diversion device 3 will be turned into the close-circuit status, allowing inputted WAN signals to be transmitted directly from the first connection port 12 to the second connection port 13 for output without through the control chip on the motherboard of the electronic device. Therefore, the invention avoids signal interruption due to short circuit, power outage or failure of the power input device 4.

In conclusion, the invention has the following benefits and features:

1. The automatic diversion device 3 is electrically connected with the first connection port 12 and the second connection port 13 to form a signal diversion loop. When the power input device 4 fails, the signal diversion component 31 of the automatic diversion device 3 will be turned into the close-circuit status, allowing inputted WAN signals to be directly transmitted from the first connection port 12 to the second connection port 13 for output without through the control chip of the motherboard of the electronic device, avoiding system interruption and enabling the system to work normally when the power of the network connector failed.

2. The first connection port 12, the second connection port 13, the filter module 2 and the automatic diversion device 3 are integrated into the inside of the electronically insulative housing 1. Such integration requires less installation space in the motherboard of the electronic device and saves much the cost. Further, subject to the operation of the automatic diversion device 3 of the network connector, it is not necessary to install an extra automatic diversion device in the motherboard of the electronic device, and therefore the invention simplifies the arrangement of control circuit, connection interface and electronic components of the motherboard of the electronic device, saving much circuit layout space.

3. The electronically insulative housing 1 is surrounded by the shield shell 14 that forms with the motherboard of the electronic device a ground loop to guide electromagnetic waves from the surroundings around the network connector and noises from the adapter circuit board 11 to the ground terminal of the electronic device for discharge to the ground, avoiding signal interference.

4. The signal diversion component 31 of the automatic diversion device 3 is installed between the filter module 21 and the first connection port 12 and second connection port 13 of the electronically insulative housing 1. When the power input device 4 fails, inputted WAN signals will be directly diverted by the automatic diversion device 3 for output without passing through the filter module 2, avoiding signal attenuation and enhancing signal transmission stability and accuracy.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A network connector, comprising:
an electronically insulative housing;
at least one first connection port and at least one second connection port installed in a front side of said electrically insulative housing;
an adapter circuit board mounted in said electrically insulative housing, said adapter circuit board comprising a plurality of first conducting terminals connected to said at least one first connection port, a plurality of second conducting terminals connected to said at least one second connection port, and a plurality of contacts;
at least one filter module installed in said adapter circuit board, each said filter module comprising a filter member electrically connected to said contacts of said adapter circuit board;
an automatic diversion device installed in said adapter circuit board, said automatic diversion device comprising a signal diversion component electrically connected to said first conducting terminals, said second conducting terminals, each said filter module and an external power input device in such a manner that when said external power input device fails, said automatic diversion device is turned into a close-circuit status, for enabling WAN signals inputted into said first connection port to be directly transmitted from said first connection port to said second connection port for output.

2. The network connector as claimed in claim 1, wherein said adapter circuit board further comprises a plurality of third conducting terminals located on a bottom side thereof and extending downwardly out of said electrically insulative housing for connection to a motherboard of an external electronic device.

3. The network connector as claimed in claim 1, further comprising a shield shell surrounding said electrically insulative housing and connected to a ground terminal of a motherboard of an external electronic device to form a ground loop.

4. The network connector as claimed in claim 1, wherein each said filter module comprises a holder, a filter member mounted in said holder member and conducting terminals mounted in said holder member at two opposite lateral sides and respectively electrically connected to said contacts of said adapter circuit board, said filter member comprising a plurality of coils respectively arranged around the conducting terminals of the respective filter module.

5. The network connector as claimed in claim 4, wherein said filter member is selected from a group consisting of resistor, capacitor, passive component and transformers.

6. The network connector as claimed in claim 1, wherein said signal diversion component of said automatic diversion device is selected from a group consisting of relay, signal switch and input/output control device.

7. The network connector as claimed in claim 1, wherein said signal diversion component of said automatic diversion device comprises a plurality of pins, one said pin being electrically connected to said external power input device such that when said external power input device is supplying electrical power to said network connector, the other said pins of said signal diversion component are electrically disconnected for enabling inputted WAN signals to be transmitted from said first connection port through said first conducting terminals of said adapter circuit board to a data processing unit on a motherboard of a linked external electronic device and then transmitted by said data processing unit to said second conducting terminals and then said second connection port for output.

8. The network connector as claimed in claim 1, wherein said signal diversion component of said automatic diversion device comprises a plurality of pins, one said pin being electrically connected to said external power input device such that when said external power input device fails, the other said pins of said signal diversion component are electrically connected for enabling inputted WAN signals to be transmitted from said first connection port through said first conducting terminals of said adapter circuit board to said second conducting terminals and then said second connection port for output.

9. The network connector as claimed in claim 1, wherein said external power input device is a power adapter/battery installed in a motherboard of an external electronic device.

10. The network connector as claimed in claim 1, wherein said first connection port and said second connection port are Ethernet compatible RJ45 interfaces.
